(19) United States
(12) Patent Application Publication
(10) Pub. No.: US 2022/0101182 A1
(43) Pub. Date: Mar. 31, 2022

(54) QUALITY ASSESSMENT OF MACHINE-LEARNING MODEL DATASET

(71) Applicant: International Business Machines Corporation, Armonk, NY (US)

(72) Inventors: Hima Patel, Bangalore (IN); Lokesh Nagalapatti, Chennai (IN); Naveen Panwar, Bangalore (IN); Nitin Gupta, Saharanpur (IN); Ruhi Sharma Mittal, Bangalore (IN); Sameep Mehta, Bangalore (IN); Shanmukha Chaitanya Guttula, Vijayawada (IN); Shazia Afzal, New Delhi (IN)

(21) Appl. No.: 17/035,111

(22) Filed: Sep. 28, 2020

(51) Int. Cl. G06N 20/00; G06N 5/04

(52) U.S. Cl. CPC G06N 20/00; G06N 5/04

(57) ABSTRACT

One embodiment provides a method, including: obtaining a dataset for use in building a machine-learning model; assessing a quality of the dataset, wherein the quality is assessed in view of an effect of the dataset on a performance of the machine-learning model, wherein the assessing comprises scoring the dataset with respect to each of a plurality of attributes of the dataset; for each of the plurality of attributes having a low quality score, providing at least one recommendation for increasing the quality of the dataset with respect to the attribute having a low quality score; and for each of the plurality of attributes having a low quality score, providing an explanation explaining a cause of the low quality score for the attribute having a low quality score.

### BACKGROUND

Machine learning is the ability of a computer to learn without being explicitly programmed to perform some function. Thus, machine learning allows a programmer to initially program an algorithm that can be used to predict responses to data, without having to explicitly program every response to every possible scenario that the computer may encounter. In other words, machine learning uses algorithms that the computer uses to learn from and make predictions regarding to data. Machine learning provides a mechanism that allows a programmer to program a computer for computing tasks where design and implementation of a specific algorithm that performs well is difficult or impossible. To implement machine learning, the computer is initially taught using machine learning models that are trained using sample inputs or training datasets. The computer can then learn from the machine learning model to make decisions when actual data are introduced to the computer.

### BRIEF SUMMARY

In summary, one aspect of the invention provides a method, comprising: obtaining a dataset for use in building a machine-learning model; assessing a quality of the dataset, wherein the quality is assessed in view of an effect of the dataset on a performance of the machine-learning model, wherein the assessing comprises scoring the dataset with respect to each of a plurality of attributes of the dataset; for each of the plurality of attributes having a low quality score, providing at least one recommendation for increasing the quality of the dataset with respect to the attribute having a low quality score; and for each of the plurality of attributes having a low quality score, providing an explanation explaining a cause of the low quality score for the attribute having a low quality score.

Another aspect of the invention provides an apparatus, comprising: at least one processor; and a computer readable storage medium having computer readable program code embodied therewith and executable by the at least one processor, the computer readable program code comprising: computer readable program code configured to obtain a dataset for use in building a machine-learning model; computer readable program code configured to assess a quality of the dataset, wherein the quality is assessed in view of an effect of the dataset on a performance of the machine-learning model, wherein the assessing comprises scoring the dataset with respect to each of a plurality of attributes of the dataset; computer readable program code configured to, for each of the plurality of attributes having a low quality score, provide at least one recommendation for increasing the quality of the dataset with respect to the attribute having a low quality score; and computer readable program code configured to, for each of the plurality of attributes having a low quality score, provide an explanation explaining a cause of the low quality score for the attribute having a low quality score.

An additional aspect of the invention provides a computer program product, comprising: a computer readable storage medium having computer readable program code embodied therewith, the computer readable program code executable by a processor and comprising: computer readable program code configured to obtain a dataset for use in building a machine-learning model; computer readable program code configured to assess a quality of the dataset, wherein the quality is assessed in view of an effect of the dataset on a performance of the machine-learning model, wherein the assessing comprises scoring the dataset with respect to each of a plurality of attributes of the dataset; computer readable program code configured to, for each of the plurality of attributes having a low quality score, provide at least one recommendation for increasing the quality of the dataset with respect to the attribute having a low quality score; and computer readable program code configured to, for each of the plurality of attributes having a low quality score, provide an explanation explaining a cause of the low quality score for the attribute having a low quality score.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a method of assessing the quality of a dataset, used in the building or training of a machine-learning model, across multiple attributes of the dataset and providing recommendations and explanations for attributes that have low quality scores.

FIG. 2 illustrates an example overall system architecture for assessing the quality of a dataset, used in the building or training of a machine-learning model, across multiple attributes of the dataset and providing recommendations and explanations for attributes that have low quality scores.

FIG. 3 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The illustrated embodiments of the invention will be best understood by reference to the figures. The following description is intended only by way of example and simply illustrates certain selected exemplary embodiments of the invention as claimed herein. It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

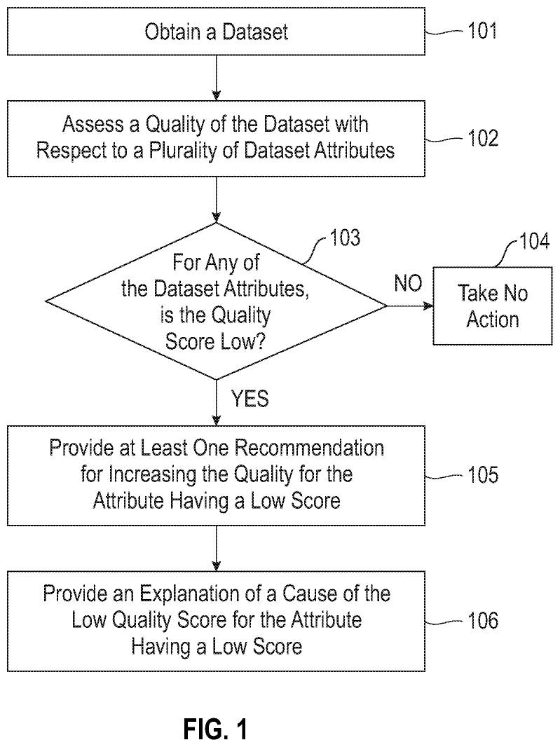

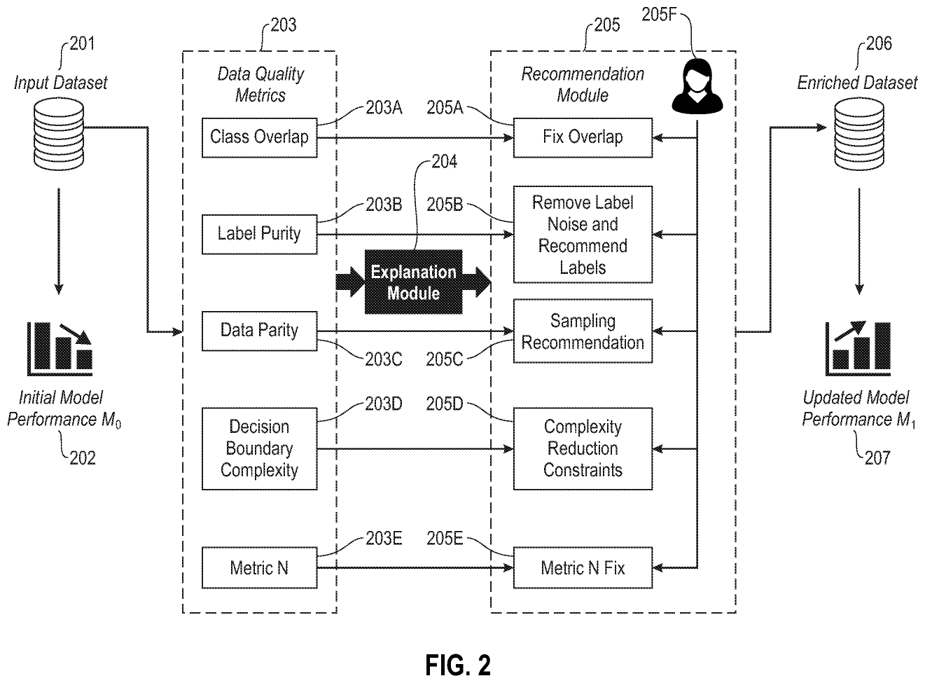

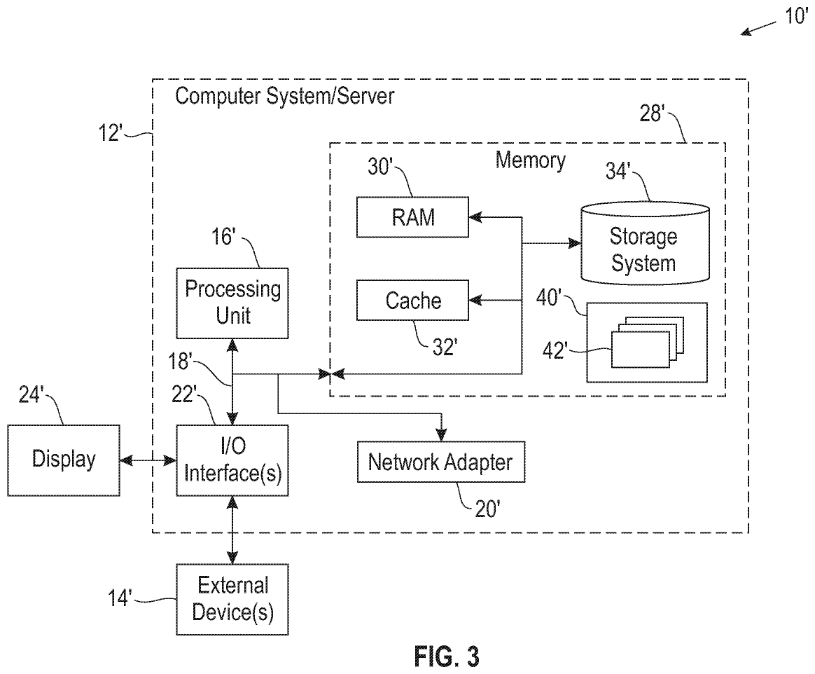

Specific reference will be made here below to FIGS. 1-3. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 3. In accordance with an example embodiment, most if not all of the process steps, components and outputs discussed with respect to FIGS. 1-2 can be performed or utilized by way of a processing unit or units and system memory such as those indicated, respectively, at 16′ and 28′ in FIG. 3, whether on a server computer, a client computer, a node computer in a distributed network, or any combination thereof.

Building and training machine-learning models is a very time-consuming task that includes many different steps. Many of the steps are based upon utilizing one or more datasets to train the machine-learning model so that accurate predictions regarding data can be made. The dataset used in building and training the machine-learning model is critical to ensuring that the model will perform as desired. Thus, the quality of the data within the dataset is very important. For example, if the dataset includes inaccurate data labels, then the machine-learning model will provide incorrect predictions. As another example, if the dataset includes many overlapping data, the machine-learning model will be unable to discern what class a piece of datum should fall within. As a final example, if the dataset includes many redundant data, the machine-learning model will be very narrowly trained and be unable to make predictions regarding data outside the training dataset.

Conventionally, ensuring data quality has been a very iterative and time-consuming task that requires the machine-learning model builder or a data scientist to spend a significant amount of time reviewing the data within the dataset, cleaning the data, and gathering additional data. Additionally, it is frequently not known if the quality of data within the dataset is bad until the model is built and trained using the dataset and then subsequently tested. Upon testing the model and receiving inaccurate predictions, the machine-learning model builder is then made aware that the original dataset is of a bad quality. However, at this point, a significant amount of time has been put into the model building process. To now have to fix the dataset or find a new dataset of a better quality requires additional time and resources, leading to a very time-consuming and frustrating model building experience. Thus, it would be beneficial to be able to ensure the quality of the data within the dataset before it is used in the model building process. However, up to this point, most work regarding machine-learning model building has focused on the building process and not on ensuring the quality of the data used to build the machine-learning model.

Accordingly, an embodiment provides a system and method for assessing the quality of a dataset, used in the building or training of a machine-learning model, across multiple attributes of the dataset and providing recommendations and explanations for attributes that have low quality scores. The described system and method obtains a dataset that it to be used in the building of a machine-learning model. Before the dataset is implemented in the machine-learning model, the system assesses the quality of the data included in the dataset. The quality assessment is performed across different attributes of the dataset, for example, boundary complexity, class parity, class overlap, label purity, and the like. While these are merely example attributes that can be assessed, the system can assess any attribute of the dataset that may have an effect on the performance of the machine-learning model.

The assessment results in a data quality score for each of the attributes of the dataset. For any of the attributes that have a low quality score the system can provide a recommendation to a data scientist, machine-learning model builder, or other user that identifies techniques that can be employed for increasing the quality of the dataset with respect to the attribute. Further, the system is able to provide an explanation that identifies the cause of the low quality score. For example, if a particular data point or data label is causing a low quality score, the system can provide an indication of this data point or data label to the user. These recommendations and explanations allow the user to quickly identify and remediate bad data included in the dataset which results in a more accurate machine-learning model than would have resulted using the original dataset. Additionally, because the quality assessment occurs before the dataset is implemented in the model, the amount of time necessary for building the model is greatly reduced.

Such a system provides a technical improvement over current systems for building machine-learning models. The described system and method provides a technique for assessing the quality of the data within a dataset before the dataset is used in the building of the machine-learning model. Such an assessment of the data quality is not provided in any conventional techniques. The system is able to assess the data across different attributes of the data that are important for building a machine-learning model. The system can then score the data with respect to these attributes. Not only is the model builder or data scientist provided with an identification of the attributes having low quality scores, but is also provided with recommendations for increasing the quality score and also an explanation of the cause of low quality scores, thereby allowing the builder or data scientist to quickly and easily remediate the data. Thus, instead of having to use a dataset in the building of a model and then testing the model to find out of the model was properly trained and built, the described system and technique is able to provide an upfront assessment of the data quality, thereby significantly reducing the amount of time spent by the model builder in identifying and fixing any data quality issues.

FIG. 1 illustrates a method for assessing the quality of a dataset, used in the building or training of a machine-learning model, across multiple attributes of the dataset and providing recommendations and explanations for attributes that have low quality scores. At 101, the system obtains a dataset that is intended to be used in building or training a machine-learning model. Obtaining the dataset may include a user or system uploading the dataset to a data storage location of the system, providing a link or pointer to the dataset to the system, or the like. Additionally, or alternatively, obtaining the dataset may include the system accessing a data storage location that stores the dataset, accessing a machine-learning model building tool that includes the dataset, or the like. In other words, obtaining the dataset can be performed in any suitable manner so that the system has access to the dataset. Additionally, different portions of the dataset may be obtained in different manners. For example, one portion of the dataset may be uploaded to the system, while another portion of the dataset is stored in a data storage location accessed by the system.

At 102, the system assesses a quality of the dataset. The quality assessment is performed in view of an effect of the dataset on the performance of a machine-learning model that would utilize the dataset. In other words, the system is interested in assessing those attributes that affect a performance of a machine-learning model and is not necessarily concerned about those dataset attributes that would not affect a performance of the machine-learning model. The overall performance of a machine-learning model is based upon many different dimensions of the machine-learning model, for example, accuracy, model runtime, model training time, model complexity, and the like. Therefore, there are many different attributes of a dataset that can affect the performance of the model since different dataset attributes could affect any one or more dimensions of the model performance.

Accordingly, the assessment of the quality is performed individually across multiple attributes of the dataset and not just a single attribute or an overall attribute of the dataset. In assessing each of the attributes, the system provides a data quality score for each attribute. Some attributes that the system may assess include a boundary complexity attribute, a class parity attribute, a class overlap attribute, a label purity attribute, and the like. The preceding four attributes will be discussed in more detail below in order to provide an explanation of how the system can perform such assessments. However, it should be understood that the system is also able to assess other attributes that affect the performance of the model and this disclosure is not intended to be limited to just these four attributes.

One dataset attribute that the system is able to assess is a boundary complexity attribute which indicates a complexity of boundaries that separate different classes within the dataset. A class can be understood to be different sections of the dataset that fall within a particular class label. For example, if the dataset is directed toward classifying images of animals, one class may include labeled images of zebras, another class may include labeled images of lions, another class may include labeled images of giraffes, and the like. Thus, using this example, the boundaries are represented by those images that separate each of the classes from other classes.

Generally, data or data labels near the boundaries are those that, if the class were defined slightly differently, would end up in a different class. Thus, the more specifically classes are defined, the more likely the boundary between classes will be more complex in order to accurately label the data falling within a particular class. However, the more complex a boundary is, the more training the model will need to accurately predict data labels. Thus, if a boundary is unnecessarily complex, an amount of error is being introduced into the model that is unnecessary. Accordingly, the system assesses not only the complexity of the boundaries, but also whether the boundaries need to be as complex as they are.

To assess the boundary complexity the system employs or utilizes an optimization framework that is specifically designed to assess the boundary complexity. Generally, in conventional systems, assessing the boundary complexity is performed using heuristic measures that are often contradictory, not applicable to most datasets, are not reliable, and that cannot accurately assess the complexity because boundary complexity cannot be assessed using a single measure. The optimization framework employed by the system imposes constraints on the optimization that levies penalties when the complexity of the function used to separate patterns of different classes is more than what is necessary. In other words, the optimization framework weights different features that affect boundary complexity such that features that cause unnecessarily more complex boundaries have lower weights than features causing less complex boundaries.

However, since some boundaries will need to be complex to accurately delineate the classes, features that help minimize the overall error rate of the machine-learning model will be weighted higher regardless of whether the feature causes a more complex boundary. If a feature contributes to the complexity of a boundary but does not minimize the overall error rate, then the feature will be weighted lower than a feature that results in a less complex boundary and that has no effect on the overall error rate. The result of the optimization framework is analyzed to compute a score for the boundary complexity. The computed score may be within any range. However, the example of a range of 0 to 1 will be used herein. In the case of the boundary complexity a score of 0 indicates a high complexity, whereas a score of 1 indicates a low complexity. An ideal complexity is as close to 1 as possible while still maintaining the accuracy of the machine-learning model. While a numeric score is described herein, it should be understood that other scoring mechanisms can be used, for example, high-medium-low values, percentages, red-green-yellow values, or any other scoring mechanism. An unnecessarily high complexity boundary will result in a low quality score for the boundary complexity attribute.

Another dataset attribute that may be assessed is a class parity attribute. Class parity refers to an imbalance in classes within a dataset. In conventional techniques, the only factor that is taken into account in determining class parity is the number of data points within each class, referred to as an imbalance ratio. For example, if one class within the dataset has one thousand data points, while another class only has ten data points, the system would identify a large class parity. However, there are other factors that contribute to class parity other than just the number of data points within each class, for example, noise ratio, dataset overlap, dataset size, and the like. Thus, the system not only takes in account the imbalance ratio, but also the other factors that contribute to class parity in assessing and scoring the class parity attribute. In generating the class parity attribute quality score, the system combines all of the factors into one score that indicates how difficult the data will be to work with due to class imbalance. In other words, the system individually assesses and scores each of the class parity factors and then aggregates these scores into a single quality score for the class parity attribute. A large class parity will result in a low class parity attribute score.

Another dataset attribute that may be assessed is a class overlap attribute. Class overlap refers to an amount of overlap between classes within a dataset. In other words, class overlap refers to the same or similar data points or data labels being found in different classes. A large amount of class overlap will result in the machine-learning model providing inaccurate predictions because the machine-learning model will be unable to discern which class a particular data point or data label actually belongs to since it is found in multiple different classes within the training dataset. Conventional techniques rely on unsupervised approaches that find isolated points that have high disagreement with a neighbor data point or data label. However, while this approach may find the points that have high disagreement, it is not an accurate or complete approach because those points that partially disagree with a neighbor are ignored or overlooked.

Accordingly, the described system utilizes a label propagation on partial disagreement points approach to find the points that not only have a high disagreement but also have a partial disagreement, thereby allowing the system to more accurately and completely identify the overlapping class regions. The label propagation on partial disagreement points approach may be an unsupervised approach. The system first identifies the data points that have a high disagreement and records these and then removes them from the dataset for purposes of the class overlap attribute assessment. In other words, the system does not actually remove these data points, but rather ignores them for the remaining steps of the process in identifying the overlapping class regions. For the remaining data points the system identifies those data points that have partial disagreement with neighboring data points. The system then propagates the labels for the data points across the data points that have the partial disagreement. Once the labels are propagated, the system can identify those regions that have overlap based upon the data points that now have the same label. Large amounts of class overlap will result in a low quality score for the class overlap attribute.

The final attribute for assessment that will be discussed herein is the label purity attribute. While this is the final attribute that will be discussed, as stated before, these are not the only attributes that the system can assess and score. The label purity attribute indicates an accuracy of labels within the dataset. Mislabeled data points will result in an inaccurate machine-learning model because it will make predictions based upon the inaccurate labels. An example of an inaccurate label is an image of a tiger labeled as a lion. If there are many such label inaccuracies, then the machine-learning model will incorrectly label images of tigers as lions. Conventional techniques rely on an algorithm that detects noisy points, or points that are incorrectly labeled. However, these conventional techniques overlook confusing points which are points that are inaccurately labeled or labeled in such a way that the machine-learning model will be unable to discern one class from another. In other words, confusing points are those points that are from different classes but show the same behavior.

The described system takes the dataset and clusters the points based upon the classes defined within the dataset. The system can compare the clusters to identify those clusters having overlapping features. This identifies those points or regions that are confusing. Additionally, the system can perform a class-wise sample probability and compute a confidence matrix. Noisy points will result in the algorithm having a high confidence regarding the noisiness of the points. Confusing points will result in the algorithm being less confident. Comparing the confusing points found by the algorithm and the confusing point regions identified through the clustering, results in a final confusing point set. The noisy points are also found in the clustering and algorithm techniques. Aggregating the noisy and confusing points results in a final list of noisy and confusing points. If the list identifies a large amount of noisy and confusing points in relation to the overall number of data points, the data quality score for the label purity attribute will be low.

After assessing the attributes of the dataset, the system determines if any of the datasets have a low quality score at 103. The term “low” refers to an undesirable or bad quality score and not necessarily to an actual value of the quality score. For example, in an example used herein a score of 0 indicates bad quality while a score of 1 indicates good quality. Thus, in this case a “low” score would refer to a score closer to 0 than to 1. To identify a low or bad score, the system may compare the quality scores of each of the attributes to a threshold value. If the score meets or exceeds the value, the score may be considered good. If the score does not meet or exceed the value, the score may be considered bad. The threshold value may be set by a user, a default value of the system, or the like. If the quality score for all of the attributes is not low or is good, the system may take no action at 104. Alternatively, the system may provide the scores to a user and let a user provide feedback or input regarding whether the user finds the score acceptable.

On the other hand, for any dataset attributes having a low quality score, the system provides at least one recommendation for increasing the quality of the dataset with respect to the attribute having the low score at 105. Additionally, for the dataset attributes having a low quality score, the system provides an explanation that explains a cause of the low quality score for the attribute at 106. Generation of the recommendation and explanation will be discussed together because the explanation of the cause generally lends itself to presenting a recommendation for remediating the low quality score. For example, if the explanation for a low quality score is that at least one data point within the dataset is causing the low score, then the recommendation may be to remove that data point from the dataset. As an example, if a data point has an incorrect label, then the data point will cause the quality score with respect to the label purity attribute to be lower. Thus, removing that data point or correcting the data label will causing an increase in the quality score.

To provide an explanation for the boundary complexity score, the system, during the optimization, keeps track of data points within the data set that result in a higher complexity and, therefore, a lower boundary complexity quality score. These data points are identified a difficult samples. If there are a few number of difficult samples, then the system makes an assumption that these difficult samples are likely not required to maintain the accuracy of the machine-learning model. Therefore, in providing the explanation the system can present a user with the difficult samples or hard data points. Presenting the difficult samples may include providing a visual representation of the difficult samples. In providing the recommendation for fixing these hard points, the system can show how the hard points can become linearly separable within a new polynomial of degree space, if a projection in a higher degree space is possible.

In providing an explanation for the class parity attribute, the system is able to identify which factor contributing to the class imbalance is causing the low quality score for the class parity attribute. In other words, since the system assesses each factor that can contribute to class parity, the system is able to identify which factor is causing the low quality score. The system can then provide an indication of this factor to a user as an explanation for why the class parity attribute has a low quality score. Further, since the system has identified which factor is causing the low quality score, the system can provide a recommendation for remediating that factor. The recommendation is usually a sampling algorithm that recommends a region or class where sampling should be performed. As an example, if the noise ratio factor is causing the low quality score, the system can recommend a sampling algorithm to reduce the noise ratio factor.

In providing an explanation for a low quality score of the class overlap attribute, the system is able to provide a list of overlapping data points. In other words, since the system identified not only those data points that had high disagreement, but also those data points that had partial disagreement, the system can provide a list of all of those points to the user. Thus, the system is able to provide a features' range-based explanation that pinpoints the overlapping regions. The explanation may be provided in a visual format. Since the system knows what data points are contributing to the class overlap, the system is able to provide a recommendation to reduce the overlap. For example, the system may provide a recommendation to add features to reduce overlap, get more samples from the overlapping regions so that the overlap is reduced, recommendation a transformation space from a pre-defined transformation that would result in less overlap, recommend a better model that would capture the classes more accurately with less overlap, or the like.

In providing an explanation for the label purity attribute, the system can utilize the noisy and confusing point list. The system may provide a visual explanation of the noisy and confusing points. The explanation may include showing how the samples differ using the algorithm versus the clustering technique. Additionally, the explanation may include identifying the confidence value with respect to a particular data point. Within the explanation the system may identify the attributes of the data points that resulted in the system determining that the point is noisy or confusing. Thus, in making a recommendation for remediating the noisy and/or confusing points the system may recommend a different feature extract, addition of features that will assist in differentiating between class samples, recommend correct labels for mislabeled points, or the like.

Once the explanations and recommendations are made, the system may request user input regarding the explanations and recommendations. For example, the system may request feedback with respect to the data quality assessment. Additionally, the user may accept some of the recommendations and the system will automatically implement the recommendation in order to increase the data quality score. The user may also manually correct or modify some of the data points or data labels in order to increase the data quality score. Once any recommendations or modifications are integrated into the dataset, the dataset may then be employed for use in building a machine-learning model.

FIG. 2 illustrates an example overall system architecture of the described system. The system obtains an input dataset 201. If this input dataset 201 were employed in the building of a machine-learning model it would result in an initial model performance 202. The system assesses the input dataset 201 across multiple different data quality metrics or attributes 203. Some of these metrics or attributes includes class overlap 203A, label purity 203B, data parity 203C, and decision boundary complexity 203D. Additionally, the system can assess the dataset across other metrics or attributes that may affect the performance of the machine-learning model, depicted as metric N 203E. Once the data has been assessed across the metrics or attributes, the system utilizes an explanation module 204 to generate and provide explanations for attributes having low quality scores.

The scores from the data quality metrics 203 and the explanations from the explanation module 204 are provided to a recommendation/remediation module 205. For example, if the class overlap attribute 203A has a low quality score, based upon the information provided from the explanation module 204, the recommendation module may provide recommendations that assist in fixing the overlap 205A. Similarly, for the label purity attribute 203B, the recommendation module may provide recommendations that remove label noise and recommend labels 205B. For the data parity attribute 203C, the recommendation module may provide a sampling recommendation 205C. For the decision boundary complexity attribute 203D, the recommendation module may provide complexity reduction constraint recommendations 205D. Any additional attributes 203E, may have corresponding recommendations 205E. The recommendation module may also use input or feedback from a user or subject matter expert 205F in identifying possible recommendations, updating recommendations, or the like.

The information from the recommendation module 205 and the initial quality assessment 203 are provided to a user so that the user can address the attributes having low quality scores. Upon implementing recommendations provided from the recommendation module 205 or other remediation measures, the resulting dataset is an enriched dataset 206 having better data quality than the initial dataset 201. When the enriched dataset 206 is implemented in the machine-learning model building process, the model performance is an updated model performance 207. This updated model performance 207 will be better than the initial model performance 202 due to the increased data quality.

Thus, the described systems and methods represent a technical improvement over current systems for building machine-learning models. In other words, the system provides an automatic data quality analysis framework or model. Since the described system assesses the quality of data within a dataset before it is implemented in the building of a machine-learning model, the amount of time that a machine-learning model builder, data scientist, or other user has to spend identifying and fixing bad quality data is greatly reduced. Thus, the amount of time that is required to build the machine-learning model is also significantly reduced. Additionally, since the user is not only provided with an assessment of the data, but also provided with recommendations for increasing the data quality and explanations for causes of low quality data, the user can quickly remediate the bad data instead of having to manually debug the data to find the bad quality data. Since a data quality assessment is not provided in conventional techniques, the described system and method provides a significant technical improvement the machine-learning model building process that is not found in conventional techniques.

As shown in FIG. 3, computer system/server 12′ in computing node 10′ is shown in the form of a general-purpose computing device. The components of computer system/server 12′ may include, but are not limited to, at least one processor or processing unit 16′, a system memory 28′, and a bus 18′ that couples various system components including system memory 28′ to processor 16′. Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12′; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method, comprising:
obtaining a dataset for use in building a machine-learning model;
assessing a quality of the dataset, wherein the quality is assessed in view of an effect of the dataset on a performance of the machine-learning model, wherein the assessing comprises scoring the dataset with respect to each of a plurality of attributes of the dataset;
for each of the plurality of attributes having a low quality score, providing at least one recommendation for increasing the quality of the dataset with respect to the attribute having a low quality score; and
for each of the plurality of attributes having a low quality score, providing an explanation explaining a cause of the low quality score for the attribute having a low quality score.

2. The method of claim 1, wherein one of the plurality of attributes comprises a boundary complexity attribute indicating a complexity of boundaries that separate classes within the dataset.

3. The method of claim 2, wherein the assessing a quality of the boundary complexity attribute comprises utilizing an optimization framework that weights different features that affect boundary complexity such that features causing more complex boundaries have lower weights than features causing less complex boundaries.

4. The method of claim 1, wherein one of the plurality of attributes comprises a class parity attribute indicating an imbalance in classes within the dataset.

5. The method of claim 4, wherein the assessing a quality of the class parity attribute comprises assessing a plurality of factors contributing to class imbalance and aggregating resulting assessment scores of the plurality of factors to generate the quality score for the class parity attribute.

6. The method of claim 1, wherein one of the plurality of attributes comprises a class overlap attribute indicating an amount of overlap between classes within the dataset.

7. The method of claim 6, wherein the assessing a quality of the class overlap attribute comprises identifying, utilizing a label propagation on partial disagreement points approach, overlapping class regions.

8. The method of claim 1, wherein one of the plurality of attributes comprises a label purity attribute indicating an accuracy of labels within the dataset.

9. The method of claim 8, wherein the assessing a quality of the label purity attribute comprises identifying both noisy and confusing data labels within the dataset.

10. The method of claim 1, wherein the providing an explanation comprises identifying at least one data point within the dataset causing the low quality score.

11. An apparatus, comprising:
at least one processor; and
a computer readable storage medium having computer readable program code embodied therewith and executable by the at least one processor, the computer readable program code comprising:
computer readable program code configured to obtain a dataset for use in building a machine-learning model;
computer readable program code configured to assess a quality of the dataset, wherein the quality is assessed in view of an effect of the dataset on a performance of the machine-learning model, wherein the assessing comprises scoring the dataset with respect to each of a plurality of attributes of the dataset;
computer readable program code configured to, for each of the plurality of attributes having a low quality score, provide at least one recommendation for increasing the quality of the dataset with respect to the attribute having a low quality score; and
computer readable program code configured to, for each of the plurality of attributes having a low quality score, provide an explanation explaining a cause of the low quality score for the attribute having a low quality score.

12. A computer program product, comprising:
a computer readable storage medium having computer readable program code embodied therewith, the computer readable program code executable by a processor and comprising:
computer readable program code configured to obtain a dataset for use in building a machine-learning model;
computer readable program code configured to assess a quality of the dataset, wherein the quality is assessed in view of an effect of the dataset on a performance of the machine-learning model, wherein the assessing comprises scoring the dataset with respect to each of a plurality of attributes of the dataset;
computer readable program code configured to, for each of the plurality of attributes having a low quality score, provide at least one recommendation for increasing the quality of the dataset with respect to the attribute having a low quality score; and
computer readable program code configured to, for each of the plurality of attributes having a low quality score, provide an explanation explaining a cause of the low quality score for the attribute having a low quality score.

13. The computer program product of claim 12, wherein one of the plurality of attributes comprises a boundary complexity attribute indicating a complexity of boundaries that separate classes within the dataset.

14. The computer program product of claim 13, wherein the assessing a quality of the boundary complexity attribute comprises utilizing an optimization framework that weights different features that affect boundary complexity such that features causing more complex boundaries have lower weights than features causing less complex boundaries.

15. The computer program product of claim 12, wherein one of the plurality of attributes comprises a class parity attribute indicating an imbalance in classes within the dataset.

16. The computer program product of claim 15, wherein the assessing a quality of the class parity attribute comprises assessing a plurality of factors contributing to class imbalance and aggregating resulting assessment scores of the plurality of factors to generate the quality score for the class parity attribute.

17. The computer program product of claim 12, wherein one of the plurality of attributes comprises a class overlap attribute indicating an amount of overlap between classes within the dataset.

18. The computer program product of claim 17, wherein the assessing a quality of the class overlap attribute comprises identifying, utilizing a label propagation on partial disagreement points approach, overlapping class regions.

19. The computer program product of claim 12, wherein one of the plurality of attributes comprises a label purity attribute indicating an accuracy of labels within the dataset.

20. The computer program product of claim 19, wherein the assessing a quality of the label purity attribute comprises identifying both noisy and confusing data labels within the dataset.
